(19) United States
(12) Patent Application Publication
(10) Pub. No.: US 2019/0031312 A1
(43) Pub. Date: Jan. 31, 2019

(54) COMPACT INTEGRATION OF ANALOG DISTRIBUTION, DIGITAL DISTRIBUTION AND BATTERY MANAGEMENT SYSTEMS

(71) Applicant: MARINE DIGITAL INTEGRATORS, LLC, Stuart, FL (US)

(72) Inventors: Russell PARKS, Port St. Lucie, FL (US); Mike STANTON, Fort Pierce, FL (US); Rick GOTWALS, Titusville, FL (US); Brian ROBINSON, Palm City, FL (US); Marcus BAILEY, Oviedo, FL (US)

(21) Appl. No.: 16/049,210

(22) Filed: Jul. 30, 2018

Related U.S. Application Data
(60) Provisional application No. 62/538,342, filed on Jul. 28, 2017.

(51) Int. Cl. B63H 21/36; B60L 11/18; H01M 10/42

(52) U.S. Cl. CPC B63H 21/36; B60R 16/033; H01M 10/4257; B60L 11/1879

(57) ABSTRACT

A battery management system comprises a housing having a bottom wall, a top wall, and a side wall extending between the bottom wall and the top wall. The side wall has an interior mounting surface and an exterior mounting surface. A plurality of electrical components are mounted on the interior mounting surface of the side wall and a plurality of electrical components are mounted on the exterior mounting surface of the side wall. The bottom wall of the housing may have an interior mounting surface. There may be a plurality of electrical components mounted on the interior mounting surface of the bottom wall. The top wall of the housing may have an interior mounting surface. There may be a plurality of electrical components mounted on the interior mounting surface of the top wall.

### CROSS-REFERENCE TO RELATED APPLICATIONS AND CLAIM TO PRIORITY

This application is related to application Ser. No. 62/538,342, filed Jul. 28, 2017, in the United States of America, the disclosure of which is incorporated herein by reference and to which priority is claimed.

### BACKGROUND OF THE INVENTION

### Field of the Invention

The present invention relates to a battery management system and, in particular, to a battery management system comprising a housing with interior mounting surfaces for mounting electrical components and exterior mounting surfaces for mounting electrical components.

### Description of the Related Art

U.S. Pat. No. 5,225,761, which issued on Jul. 6, 1993 to Albright and U.S. Pat. No. 5,448,152, which issued on Sep. 5, 1996 to Albright disclose a battery management system which maintains a charge on at least one auxiliary battery by switching the auxiliary battery automatically into parallel with the main battery charging circuit or with the auxiliary load. The system uses the AC component of the charging signal of a vehicle or boat charging system to trigger switching circuits coupled to operate relays or similar switching means which couple the auxiliary battery to the main charging circuit. When no charging signal is present, i.e., when the vehicle or boat engine is turned off, the auxiliary battery is switched automatically out of the charging system and is charged and in condition for use. A delay circuit can be provided for providing non-shorting operation, especially for use with more than one auxiliary battery which batteries are charged in parallel and loaded in series, whereby the combined series voltage of the auxiliary batteries would exceed the vehicle or boat supply voltage. The timing circuits open the circuit from the auxiliary batteries to the vehicle or boat charging system prior to switching the batteries into a series configuration for use with a load requiring a voltage higher than the rated voltage of the charging system. The timing circuits thereby prevent momentary large currents upon changes of state.

### SUMMARY OF THE INVENTION

It is an object of the present invention to provide a battery management system with a housing having interior mounting surfaces for mounting electrical components and exterior mounting surfaces for mounting electrical components.

It is also an object of the present invention to provide a compact integration of analog distribution, digital distribution and battery management systems.

There is accordingly provided a battery management system comprising a housing having a bottom wall, a top wall, and a side wall extending between the bottom wall and the top wall. The side wall has an interior mounting surface and an exterior mounting surface. A plurality of electrical components are mounted on the interior mounting surface of the side wall and a plurality of electrical components are mounted on the exterior mounting surface of the side wall. The electrical components mounted on the interior mounting surface of the side wall may be electrical components with lower corrosion resistance. The electrical components mounted on the exterior mounting surface of the side wall may be electrical components that allow for user interaction. The electrical components mounted on the exterior mounting surface of the side wall may extend through the side wall. The bottom wall of the housing may have an interior mounting surface. There may be a plurality of electrical components mounted on the interior mounting surface of the bottom wall. The top wall of the housing may have an interior mounting surface. There may be a plurality of electrical components mounted on the interior mounting surface of the top wall. The top wall of the housing may be a hinged cover of the housing. An interior of the housing may be sealed when the housing is closed. The housing may be water resistant. The housing may be fire resistant.

There is also provided a battery management system comprising a housing having a bottom wall and a top wall. There is a first side wall extending between the bottom wall and the top wall. The first side wall has an interior mounting surface and there are a plurality of electrical components mounted on the interior mounting surface of the first side wall. The first side wall has an exterior mounting surface and there are a plurality of electrical components mounted on the exterior surface of the first side wall. There is a second side wall extending between the bottom wall and the top wall. The second side wall has an interior mounting surface and there are a plurality of electrical components mounted on the interior mounting surface of the second side wall. The second side wall has an exterior mounting surface and there are a plurality of electrical components mounted on the exterior mounting surface of the second side wall. There is a third side wall extending between the bottom wall and the top wall. The third side wall has an interior mounting surface and there are a plurality of electrical components mounted on the interior mounting surface of the third side wall. The third side wall has an exterior mounting surface and there are a plurality of electrical components mounted on the exterior mounting surface of the third side wall. There is a fourth side wall extending between the bottom wall and the top wall. The fourth side wall has an interior mounting surface and there are a plurality of electrical components mounted on the interior mounting surface of the fourth side wall. The bottom wall of the housing may have an interior mounting surface and there may be a plurality of electrical components mounted on the interior mounting surface of the bottom wall. The top wall of the housing may have an interior mounting surface and there may be a plurality of electrical components mounted on the interior mounting surface of the top wall. The top wall of the housing may be a hinged cover of the housing. An interior of the housing may be sealed when the housing is closed. The housing may be water resistant. The housing may be fire resistant.

There is further provided a battery management system comprising a housing having a top wall. There is a first side wall extending from the top wall. The first side wall has an interior mounting surface and there are a plurality of electrical components mounted on the interior mounting surface of the first side wall. The first side wall has an exterior mounting surface and there are a plurality of electrical components mounted on the exterior surface of the first side wall. There is a second side wall extending from the top wall. The second side wall has an interior mounting surface and there are a plurality of electrical components mounted on the interior mounting surface of the second side wall. The second side wall has an exterior mounting surface and there are a plurality of electrical components mounted on the exterior mounting surface of the second side wall. There is a third side wall extending from the top wall. The third side wall has an interior mounting surface and there are a plurality of electrical components mounted on the interior mounting surface of the third side wall. The third side wall has an exterior mounting surface and there are a plurality of electrical components mounted on the exterior mounting surface of the third side wall. The housing may not have a bottom wall. At least one side of the housing may not have a side wall. The top wall of the housing may have an interior mounting surface and there may be a plurality of electrical components mounted on the interior mounting surface of the top wall. The top wall of the housing may be a hinged cover of the housing. An interior of the housing may be sealed when the housing is closed. The housing may be water resistant. The housing may be fire resistant.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of a marine vessel provided with a battery management system;

FIG. 2 is a perspective view of a housing of the battery management system:

FIG. 3 is a perspective view of an interior of the housing of the battery management system;

FIG. 4 is an elevation view of a first side wall of the housing of the battery management system;

FIG. 5 is an elevation view of a second side wall of the housing of the battery management system;

FIG. 6 is an elevation view of a third side wall of the housing of the battery management system; and

FIG. 7 is a schematic of the electrical system of the marine vessel.

### DESCRIPTIONS OF THE PREFERRED EMBODIMENTS

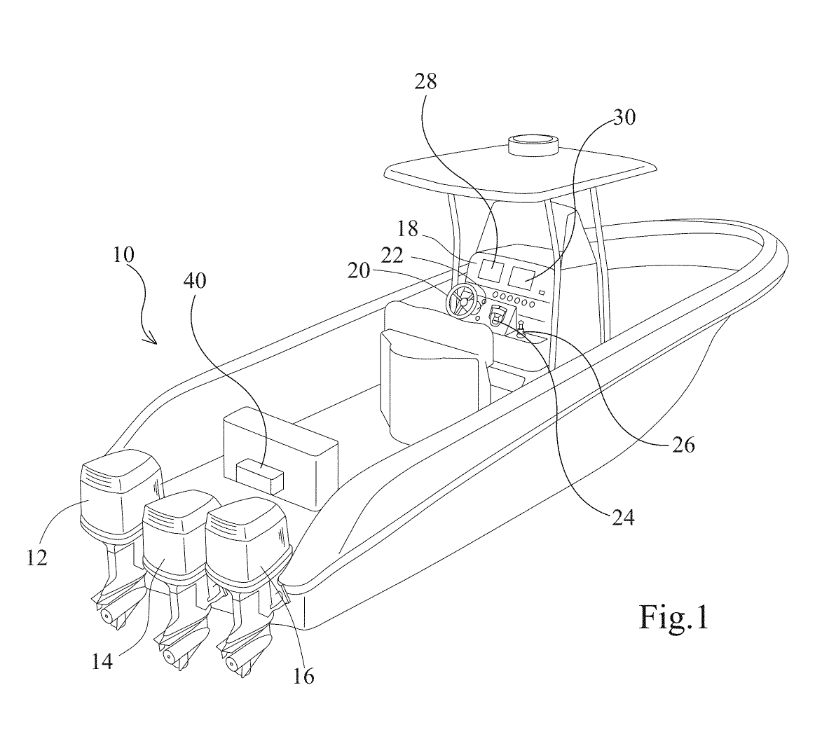

Referring to the drawings and first to FIG. 1, there is shown a marine vessel 10 which is provided with a plurality of propulsion units which, in this example, are in the form of three outboard engines, namely, a port engine 12, a center engine 14, and a starboard engine 16. However, the propulsion units may be any number or form of propulsion units in other examples. The marine vessel 10 is also provided with a control station 18 that supports a steering wheel 20 mounted on a helm 22, a control head 24, and a joystick 26. The control station 18 is conventional and allows the port engine 12 and the starboard engine 16 to be steered using either the steering wheel 20 and the helm 22 or the joystick 26 as disclosed in PCT International Application Publication Number WO 20131123208 A1 which is incorporated herein by reference. The control station 18 further includes a first display interface 28 and a second display interface 30. In this example, the first display interface is a SIMRAD® display interface which displays navigational information and the second display interface is a BEP® display which displays onboard system information.

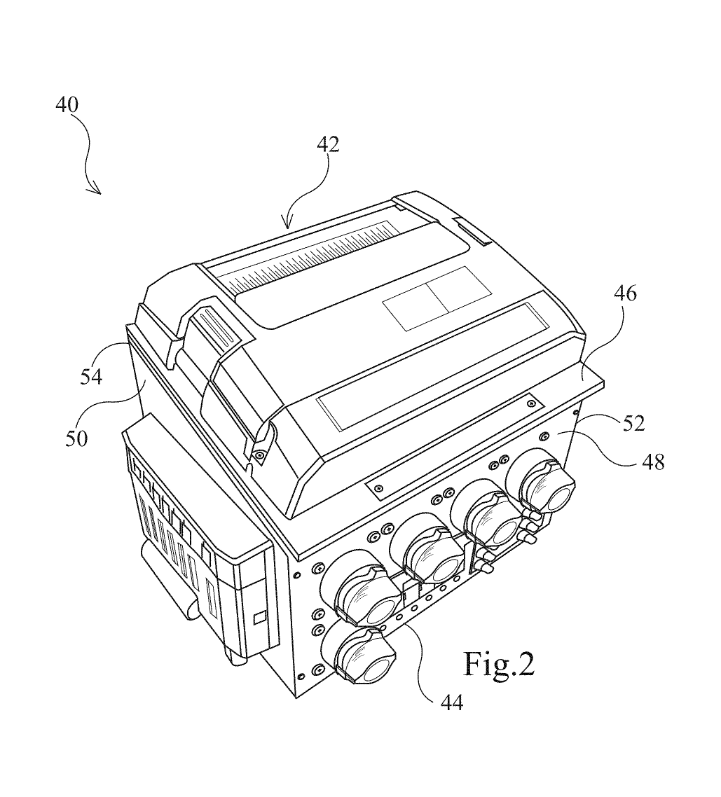

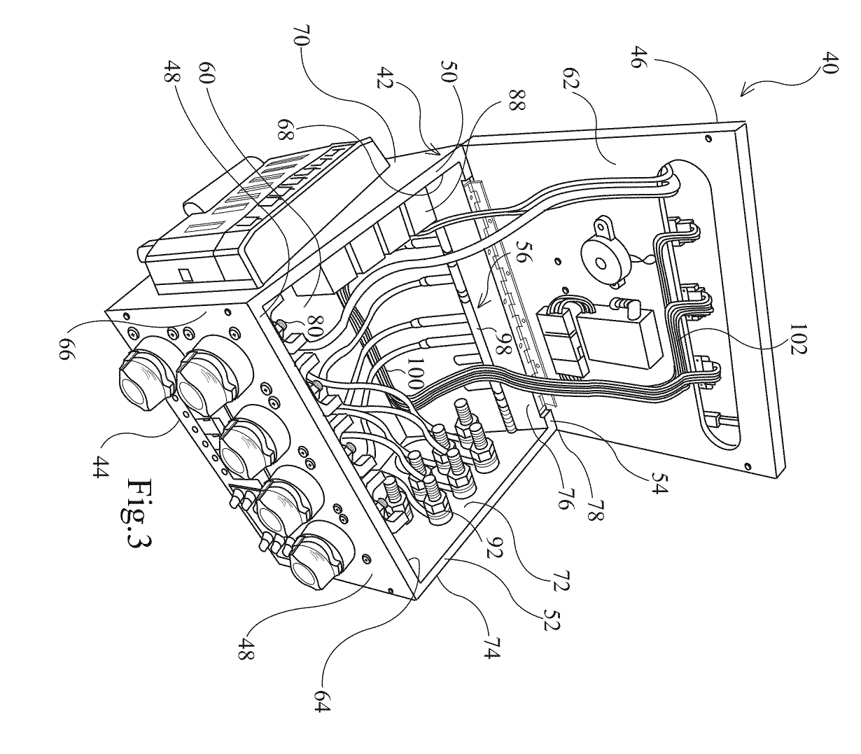

The marine vessel also includes a compact integration of digital distribution, analog distribution and battery management systems, namely, a battery management system 40 as part of a compact integration of which may be disposed in any suitable location on the marine vessel 10. The battery management system 40 is shown in greater detail in FIG. 2. The battery management system 40 includes a housing 42 which, in this example, has a bottom wall 44, a top wall 46, a first side wall 48, a second side wall 50, a third side wall 52, and a fourth side wall 54. The bottom wall 44 of the housing 42 is configured to be mounted to the marine vessel 10 and allows the battery management system 40 to be seated without shorting electrical circuits. The top wall 46 of the housing 42 is a hinged cover of the housing which allows access to an interior 56 of the housing which is shown in FIGS. 3. The interior 56 of the housing 42 may be sealed when the housing is covered. The housing may also be water resistant and/or fire resistant.

Referring to FIGS. 3A and 3B, the bottom wall 44 of the housing 42 has an interior mounting surface 60 and the top wall 46 has an interior mounting surface 62. The first side wall 48 of the housing 42 is a front of the housing and has an interior mounting surface 64 and an exterior mounting surface 66. The second side wall 50 of the housing 42 is a port side of the housing and has an interior mounting surface 68 and an exterior mounting surface 70. The third side wall 52 of the housing 42 is a starboard side of the housing and has an interior mounting surface 72 and an exterior mounting surface 74. The fourth side wall 54 of the housing 42 is a back of the housing and may be configured to be mounted to the marine vessel 10. The fourth side wall 54 of the housing 42 also has an interior mounting surface 76 and an exterior mounting surface 78. Electrical components are mounted on the interior mounting surface and the exterior mounting surfaces.

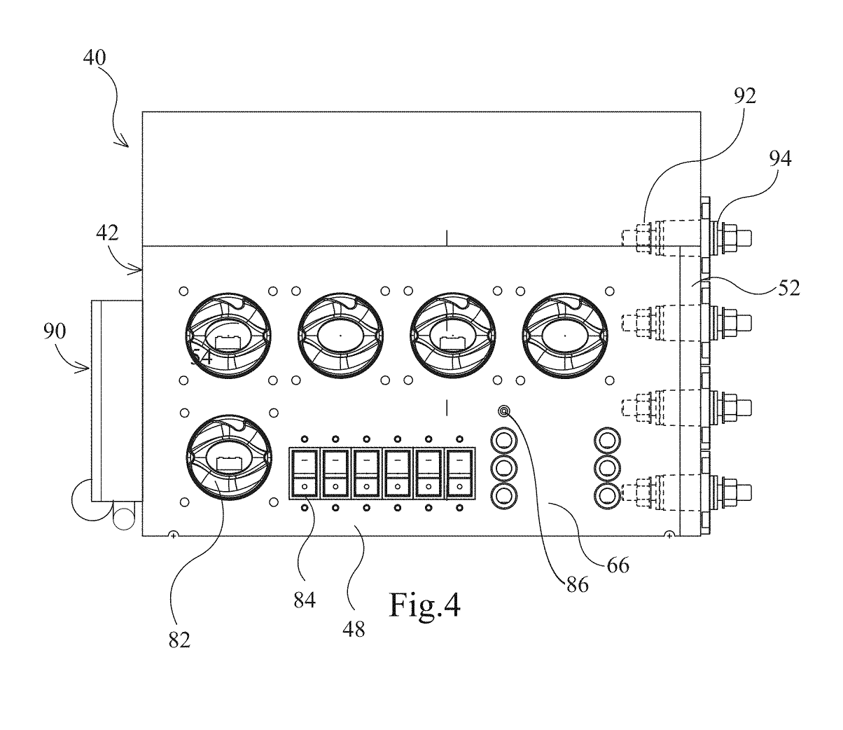

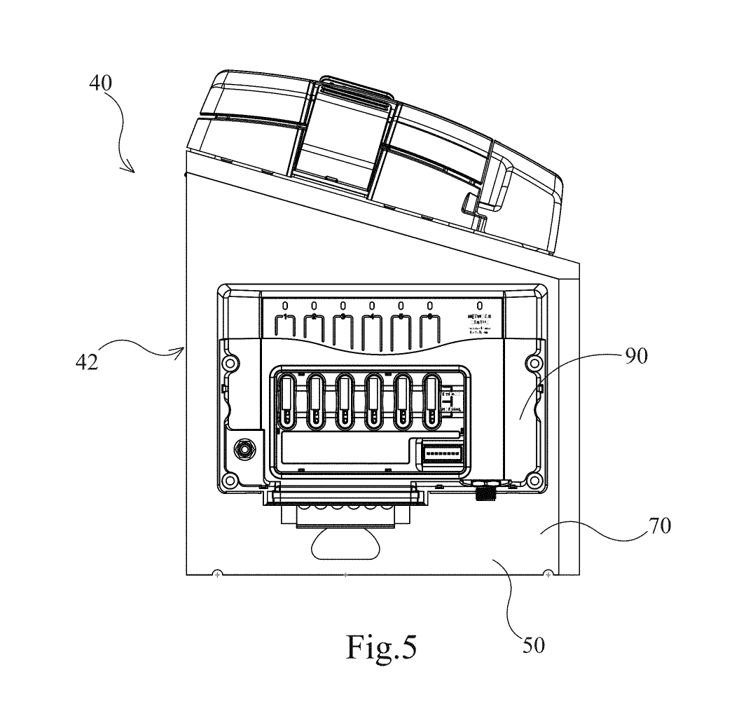

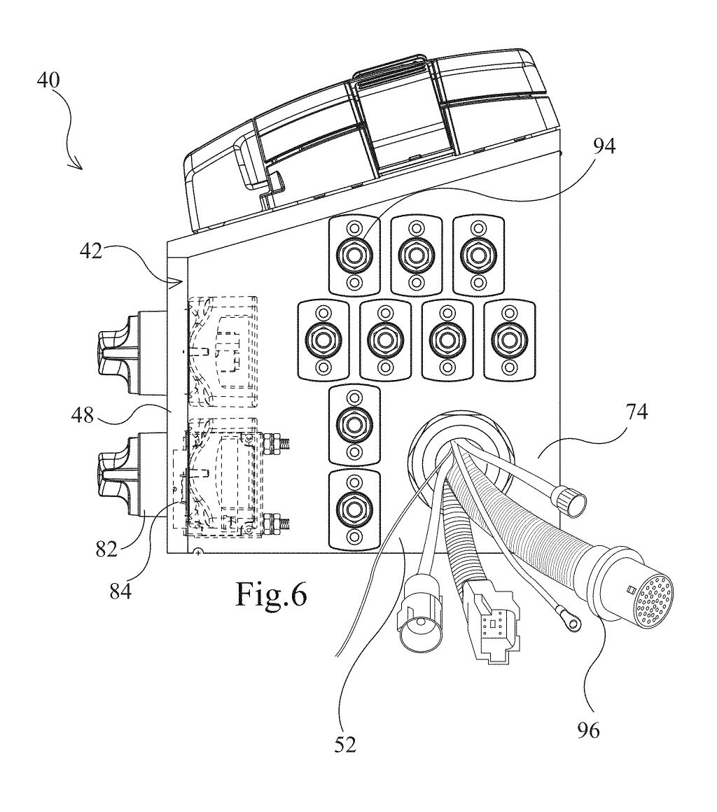

There are electrical components, for example a battery disconnect switch 80, mounted on the interior mounting surface 64 of the first side wall 48 of the housing 42 as shown in FIG. 3. There are also electrical components, for example a battery switch 82, a rocker type circuit breaker 84 and an LED indicator 86, mounted on the exterior mounting surface 66 of the first side wall 48 of the housing as shown in FIG. 4. There are electrical components, for example an electrical relay 88, mounted on the interior mounting surface 68 of the second side wall 50 of the housing 42 as shown in FIG. 3. There are also electrical components, for example a digital switching component 90, mounted on the exterior mounting surface 70 of the second side wall 50 of the housing 42 as shown in FIG. 5. There are electrical components, for example an feed through connector 92, mounted on the interior mounting surface 72 of the third side wall 52 of the housing 42 as shown in FIG. 3. There are also electrical components, for example an exterior 94 of the feed through connector 92, mounted on the exterior mounting surface 74 of the third side wall 52 of the housing as shown in FIG. 6. There is also cabling 96 which allow the battery management system 40 to be electrically connected to an electrical system of the marine vessel 10. There are electrical components, for example an electrical relay 98, mounted on an interior mounting surface 76 of the fourth side wall 54 as shown in FIG. 3. Electrical components mounted on the interior mounting surfaces are protected from foreign elements which allows for the use of components with lower corrosion resistance. Electrical components mounted on the exterior mounting surfaces allow for user interaction such as switching between modes and monitoring the status of the battery switches.

There may also be electrical components, for example wiring 100, mounted on the interior mounting surface 60 of the bottom wall 44 as shown in FIG. 3. There may also be electrical components, for example wiring 102, mounted on the interior mounting surface 62 of the top wall 46 of the housing 42 as shown in FIG. 3. Electrical components may also extend though the side walls. FIG. 4 shows the feed through connector 92 extending through the third side wall 52 of the housing 42 and FIG. 6 shows the battery switch 82 extending through the first side wall 48 of the housing 42. This allows for shorter wire routing to reduce resistance.

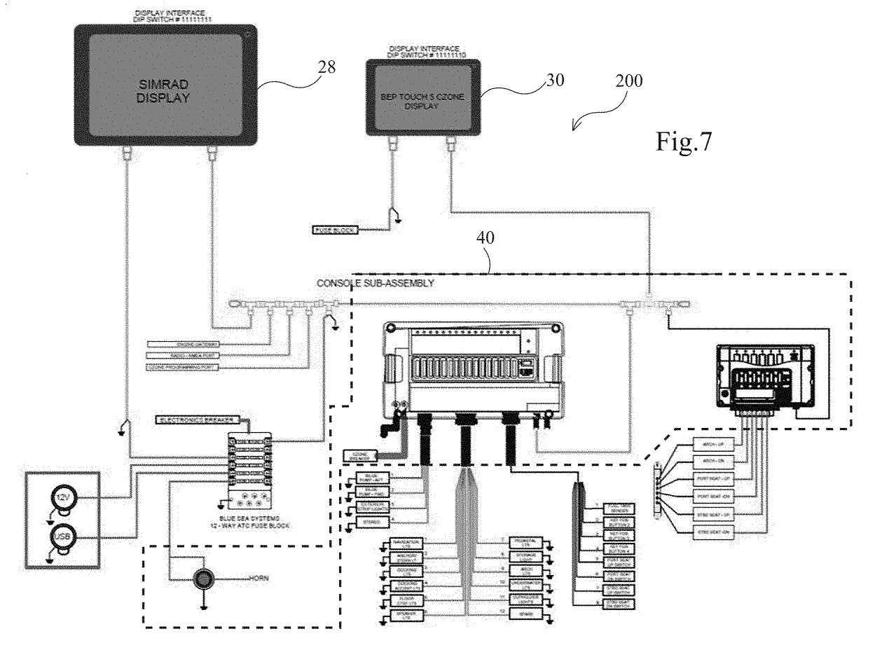

FIG. 7 is a schematic of an electrical system 200 of the marine vessel 10 showing the communication between the battery management system 40 the first display interface 28 and the second display interface 30. The battery management system 40 disclosed herein centralizes all electrical components in a single location to allow for easy installation, troubleshooting and maintenance of the electrical system 200 of the marine vessel 10. The pre-wired nature of the battery management system 40 reduces the risk of incorrectly configured electrical circuits.

In other examples, the housing of the battery management system may not have a bottom wall and the housing of the battery management system may be mounted to a surface of the marine vessel, for example the deck of the marine vessel, with said surface of the marine vessel functioning as the bottom wall of the housing of the battery management system. Alternatively, a side of the housing of the battery management system may not have a side wall and the housing of the battery management system may be mounted to a surface of the marine vessel, for example a bulkhead of the marine vessel, with said surface of the marine vessel functioning as the side wall of the housing of the battery management system.

It will be understood by a person skilled in the art that many of the details provided above are by way of example only, and are not intended to limit the scope of the invention which is to be determined with reference to the following claims.

What is claimed is:

1. A battery management system comprising:
a housing having a bottom wall and a top wall;
a first side wall extending between the bottom wall and the top wall, the first side wall having an interior mounting surface with a plurality of electrical components mounted thereon, and the first side wall having an exterior mounting surface with a plurality of electrical components mounted thereon;
a second side wall extending between the bottom wall and the top wall, the second side wall having an interior mounting surface with a plurality of electrical components mounted thereon, and the second side wall having an exterior mounting surface with a plurality of electrical components mounted thereon;
a third side wall extending between the bottom wall and the top wall, the third side wall having an interior mounting surface with a plurality of electrical components mounted thereon, and the third side wall having an exterior mounting surface with a plurality of electrical components mounted thereon; and
a fourth side wall extending between the bottom wall and the top wall, the fourth side wall having an interior mounting surface with a plurality of electrical components mounted thereon.

2. The battery management system as claimed in claim 1 wherein the bottom wall of the housing has an interior mounting surface and there are a plurality of electrical components mounted on the interior mounting surface of the bottom wall.

3. The battery management system as claimed in claim 1 wherein the top wall of the housing has an interior mounting surface and there are a plurality of electrical components mounted on the interior mounting surface of the top wall.

4. The battery management system as claimed in claim 1 wherein the top wall of the housing is a hinged cover of the housing.

5. The battery management system as claimed in claim 1 wherein an interior of the housing is sealed.

6. The battery management system as claimed in claim 1 wherein the housing is water resistant.

7. The battery management system as claimed in claim 1 wherein the housing is fire resistant.

8. A battery management system comprising:
a housing having a top wall;
a first side wall extending from the top wall, the first side wall having an interior mounting surface with a plurality of electrical components mounted thereon, and the first side wall having an exterior mounting surface with a plurality of electrical components mounted thereon;
a second side wall extending from the top wall, the second side wall having an interior mounting surface with a plurality of electrical components mounted thereon, and the second side wall having an exterior mounting surface with a plurality of electrical components mounted thereon; and
a third side wall extending from the top wall, the third side wall having an interior mounting surface with a plurality of electrical components mounted thereon, and the third side wall having an exterior mounting surface with a plurality of electrical components mounted thereon.

9. The battery management system as claimed in claim 8 wherein the housing does not have a bottom wall.

10. The battery management system as claimed in claim 8 wherein at least one side of the housing does not have a side wall.

11. The battery management system as claimed in claim 8 wherein the top wall of the housing has an interior mounting surface and there are a plurality of electrical components mounted on the interior mounting surface of the top wall.

12. The battery management system as claimed in claim 8 wherein the top wall of the housing is a hinged cover of the housing.

13. The battery management system as claimed in claim 8 wherein an interior of the housing is sealed.

14. The battery management system as claimed in claim 8 wherein the housing is water resistant.

15. The battery management system as claimed in claim 8 wherein the housing is fire resistant.
